(19) United States
(12) Patent Application Publication
(10) Pub. No.: US 2026/0287827 A1
(43) Pub. Date: Sep. 24, 2026

(54) Interconnecting a hollow-core fibre with a standard silica single-mode fibre

(71) Applicant: ORANGE, ISSY LES MOULINEAUX (FR)

(72) Inventor: Philippe CHANCLOU, Chatillon (FR)

(21) Appl. No.: 19/140,423

(22) PCT Filed: Dec. 20, 2023
(86) PCT No.: PCT/EP2023/086963

§ 371 Date: Jun. 9, 2026

(30) Foreign Application Priority Data
Dec. 22, 2022 (FR) FR2214235

(51) Int. Cl. G02B 6/38

(52) U.S. Cl. CPC G02B 6/3845

(57) ABSTRACT

A coupling device for coupling a single-mode or multicore optical fiber, referred to as a solid fiber, to a hollow-core optical fiber. The device includes a graded-index fiber section), wherein: the coupling device is coupled to a core of the solid fiber with a radial offset with respect to the center axis of the graded-index fiber section; the coupling device is coupled to the hollow-core fiber at an angle with respect to a plane orthogonal to the center axis, the angle of which is proportional to the radial offset and to parameters of the graded-index fiber.

### 1. FIELD OF THE INVENTION

The invention is in the field of optical data transmission, and more specifically in the field of interconnecting between a single-mode optical fiber and a hollow-core fiber.

### 2. PRIOR ART

The single-mode optical fiber is made up of silica with an optical sheath and an optical core in which the optical beam propagates. The optical index of the core is slightly higher than that of the sheath. In a multi-core fiber, a single optical sheath surrounds a plurality of spatially distributed optical cores. The hollow-core fiber is made up of a microstructure of silica and air with a core mainly made up of air in which the optical beam propagates. Interconnecting a single-mode fiber and a hollow-core fiber involves adapting the size of the optical beam between these two types, with the optical beam diameter being around 9 μm for the single-mode fiber and around 30 μm for the hollow-core fiber.

The article entitled “Interconnecting hollow-core fibers”, 2021, IEEE Photonics Society Summer Topicals Meeting Series (SUM), 2021, pp. 1-2, by M. Komanec et al., describes several devices whose purpose is to implement this matching while minimizing optical losses.

However, the disadvantage of these solutions is that they do not sufficiently minimize optical reflection in each of the transmission directions, or they are not simple or compact enough to be readily producible and deployable.

One of the aims of the invention is to overcome these disadvantages of the prior art.

### 3. DISCLOSURE OF THE INVENTION

The invention improves the situation using a device for coupling between a single-mode or multi-core optical fiber, called solid fiber, and a hollow-core optical fiber, comprising a graded-index fiber section, wherein:
the coupling device is coupled to a core of the solid fiber with a radial offset relative to the central axis of the graded-index fiber section;
the coupling device is coupled to the hollow-core fiber at an angle relative to a plane orthogonal to the central axis, with the angle being proportional to the radial offset and to parameters of the graded-index fiber.

Throughout the remainder of the description, the term “solid fiber” equally denotes a single-core single-mode optical fiber, and a multi-core optical fiber. In the direction extending from the solid fiber to the hollow-core fiber, the radial offset introduces an angle at the output of the optical device made up of a graded-index section and prevents an optical reflection from returning to the core of the solid fiber. The so-called “radial” offset can be in a plane perpendicular to the central axis of the device, or can be slightly inclined relative to this plane.

In the other transmission direction, the cleavage allows any optical reflection to be deflected outside the central axis of the hollow core.

The combination removes or significantly reduces optical reflections in both propagation directions, while allowing matching to the diameters of the modes of the fibers at each end.

In addition, by cleaving the hollow-core fiber at the same angle as that of the device, welding allows the following to be aligned in the same axis: the solid fiber, the coupling device, and the hollow-core fiber, thereby facilitating the mechanical assembly of the various sections. Indeed, when assembling, by welding, for example, the hollow-core fiber does not need to be mechanically held at a certain angle relative to the device, with the precision of the angle being difficult to ensure and maintain.

Obtaining a precise offset by means of mechanical misalignment of the solid fiber relative to the device can be difficult, but this operation is not necessary if the solid fiber is a multi-core fiber. Indeed, since at least one of the cores of the multi-core fiber is already off-centered relative to the central axis of the device, mechanical lateral misalignment does not need to be introduced.

According to one aspect of the coupling device, it further comprises at least one pure silica section adjacent to one side and/or the other side of the graded-index fiber section.

The pure silica section does not have a core, and the optical beam homogeneously disperses therein. This allows the optical parameters of the lens system thus included in the device to be modified, and allows this device to be rendered independent of the index filter of the graded-index section. A significant choice of graded indices is therefore possible, for the same solid fiber/hollow-core fiber pair.

According to one aspect of the coupling device, the pure silica section is located between the solid fiber and the graded-index fiber section.

By virtue of this aspect, the “object” distance (between the solid fiber and the graded-index section) of the optical system made up of the graded-index lens can be configured and allows the magnification and focusing parameters of the optical beam to be modified.

According to one aspect of the coupling device, the pure silica section is located between the graded-index fiber section and the hollow-core fiber.

By virtue of this aspect, the “image” distance (between the graded-index section and the hollow-core fiber) of the optical system made up of the graded-index lens can be configured and allows the magnification and focusing parameters of the optical beam to be modified.

According to one aspect of the coupling device, it comprises a first pure silica section located between the solid fiber and the graded-index fiber section, and a second pure silica section located between the graded-index fiber section and the hollow-core fiber.

By virtue of this aspect, both the object distance and the image distance of the optical system made up of the graded-index lens can be configured and can allow the magnification and focusing parameters of the optical beam to be modified.

According to one aspect of the coupling device, the graded-index fiber section is welded to the hollow-core fiber.

According to one aspect of the coupling device, the pure silica section is welded to the hollow-core fiber.

The invention further relates to a method for manufacturing a coupling device between a single-mode or multi-core optical fiber, called solid fiber, and a hollow-core fiber, comprising:
welding the solid fiber to a graded-index fiber section, or to a pure silica section itself welded to the graded-index fiber section, with a radial offset of a core of the solid fiber relative to the central axis of the graded-index fiber section;
splitting the graded-index fiber section in order to give it a defined length, involving cleaving relative to a plane orthogonal to the central axis if the graded-index fiber is directly welded to the hollow-core fiber, with the angle being proportional to the offset and to parameters of the graded-index fiber;
welding the hollow-core fiber to the graded-index fiber section, or to a pure silica section itself welded to the graded-index fiber section with the cleavage;
   with the solid fiber, the graded-index section and the hollow-core fiber being parallel to each other.

This method allows coupling to be obtained between a solid fiber and a hollow-core fiber, with a significant reduction in optical reflections, simply by means of electric arc welds.

It also allows a simple mechanical assembly to be obtained following the natural alignment of the structures of the fibers. The length of the graded-index fiber section is computed to allow this fiber section to function as a lens with a focal length. The pure silica sections allow, throughout the graded-index section, the object and image distances of the solid and hollow fibers to be adjusted.

### 4. DESCRIPTION OF THE FIGURES

Further advantages and features of the invention will become more clearly apparent upon reading the following description of a particular embodiment of the invention, which is provided by way of a simple illustrative and non-limiting example, and the appended drawings, in which:

FIG. 1 shows a first aspect of a first embodiment of a coupling device between a single-mode or multi-core optical fiber, called solid fiber, and a hollow-core optical fiber, comprising a graded-index fiber section;

FIG. 2 shows a second aspect of this first embodiment;

FIG. 3 shows a third aspect of this first embodiment;

FIG. 4 shows a fourth aspect of this first embodiment;

FIG. 5 shows a first aspect of a second embodiment of the coupling device;

FIG. 6 shows a second aspect of this second embodiment,

FIG. 7 shows a third aspect of this second embodiment;

FIG. 8 shows a fourth aspect of this second embodiment;

FIG. 9 shows a fifth aspect of this second embodiment;

FIG. 10 shows a first aspect of a third embodiment of the coupling device;

FIG. 11 shows a second aspect of this third embodiment;

FIG. 12 shows a third aspect of this third embodiment;

FIG. 13 shows a fourth aspect of this third embodiment, and FIGS. 14 to 23 show embodiments with ferrules.

### 5. DETAILED DESCRIPTION OF AT LEAST ONE EMBODIMENT OF THE INVENTION

One solution involves using weld assembling for joining various types of fiber portions or sections in order to implement mode matching and reduce optical reflections. Weld assembling different types of fiber portions also produces a compact coupling device. Welding remains the preferred assembly mode but bonding or mechanically assembling by juxtaposing the sections can be contemplated. If necessary, it is possible to include an index liquid between the sections in order to limit or remove a fiber/air/fiber interface. In one embodiment, the coupling device comprises a graded-index fiber section Fgi juxtaposed by welding (or any other means) to a single-mode fiber Fms on one side and to a hollow-core fiber Fcc on the other side. The length of the graded-index fiber section Fgi is computed so as to match the optical beams.

The principle is to match the diameter of the optical beam by inserting a graded-index fiber section Fgi with a size of a few microns to a few millimeters. One or two fiber sections Fsp1, Fsp2 made up of pure silica can be inserted in order to modify the optical parameters of the lens system thus included in the coupling device.

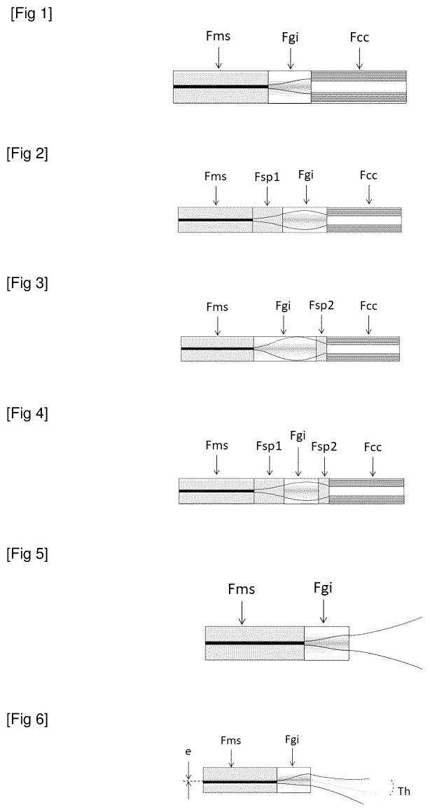

FIGS. 1 to 4 illustrate 4 variants of this embodiment of such a coupling device, respectively:
without any pure silica fiber section ([FIG. 1]): the coupling device is then made up of an interface with a solid fiber, a graded-index fiber section, and an interface with a hollow-core fiber;
with a single pure silica section Fsp1, disposed between the single-mode fiber Fms and the graded-index fiber section Fgi ([FIG. 2]): the coupling device is then made up of an interface with a solid fiber, a pure silica section (Fsp1), a graded-index fiber section, and an interface with a hollow-core fiber;
with a single pure silica section Fsp2 disposed between the graded-index fiber section Fgi and the hollow-core fiber Fcc ([FIG. 3]): the coupling device is then made up of an interface with a solid fiber, a graded-index fiber section, a pure silica section (Fsp2), and an interface with a hollow-core fiber;
with a pure silica section Fsp1 and a pure silica section Fsp2 disposed on both sides of the graded-index fiber section Fgi ([FIG. 4]): the coupling device is then made up of an interface with a solid fiber, a pure silica section (Fsp1), a graded-index fiber section, a pure silica section (Fsp2), and an interface with a hollow-core fiber.

Such a coupling device allows the optical beam of around 9 μm of the silica single-mode fiber Fms to be matched to that of 30 μm of the hollow-core fiber Fcc. However, the silica/air diopter introduces a reflection of around −14.5 dB.

In one embodiment, this principle is improved by introducing an angle at the output of the coupling device. To this end, the core of the single-mode fiber Fms needs to be offset relative to the optical axis of the device, preferably perpendicularly. The angle is proportional to the offset of the core of the single-mode fiber and the parameters of the graded-index fiber. The angle Th is defined by the formula:

$$Th = e n 0 g 0$$

with e being a measurement of the offset of the axis of the core of the single-mode fiber Fms relative to the optical axis, n0 being the index at the center of the graded-index fiber and g0 being the quadratic coefficient of the graded index.

FIGS. 5 and 6 illustrate the effect of such a zero and non-zero offset, respectively, on the optical beam output from the coupling device.

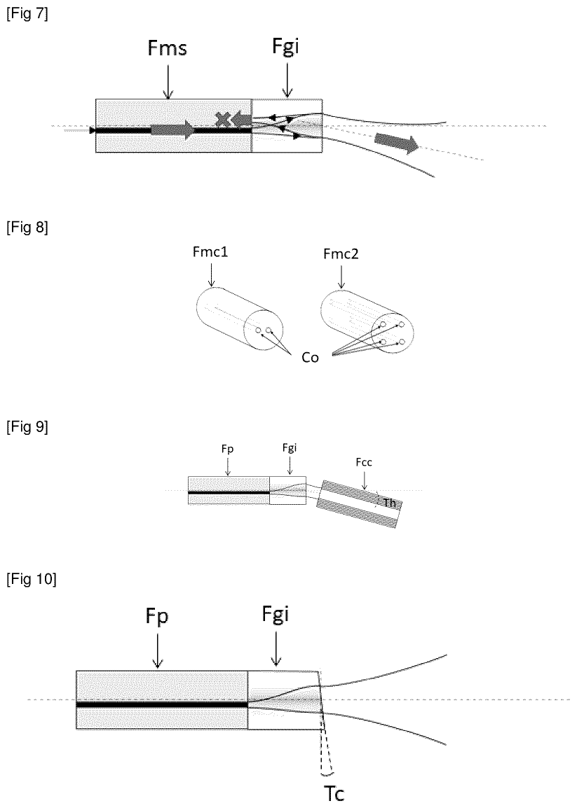

The advantage of this offset is that it allows the optical reflection of the optical beam originating from the single-mode fiber Fms to be limited. Indeed, as illustrated in [FIG. 7], the reflected beam will again propagate in the graded-index section Fgi so as to be focused in an area inversely offset relative to the core of the single-mode fiber Fins.

As seen above, the offset of the core required at the angle at the output from the coupling device can be obtained by using a standard single-mode fiber that is welded with a lateral misalignment (perpendicular to the axis of the fiber) relative to the graded-index fiber.

In another embodiment, this effect is obtained with a multi-core fiber, welded without any lateral misalignment. Indeed, as illustrated in [FIG. 8], none of the cores Co of the 2-core multi-core fiber Fmc1, or of the 4-core multi-core fiber Fmc2, is in the central axis of the fiber; in other words they are all already offset relative to this axis.

The various embodiments can be applied to a single-mode fiber or to a multi-core fiber, and the term “solid fiber”, denoted Fp, is used to equally designate either type of fiber.

In order for the device to be properly coupled with the hollow-core fiber Fcc, this fiber can be aligned at the angle Th of the device, as illustrated in [FIG. 9]. This device has the disadvantage of not maintaining perfect alignment between the fiber Fp, the fiber Fcc and the coupling device, which prevents mechanical retention by welding, for example.

According to one embodiment illustrated in [FIG. 10], the coupling device is improved by introducing a cleavage angle Tc at its end, proportional to the angle Th of the optical beam. This allows an optical beam to be provided at the output of the coupling device that is parallel and centered on the axis of the coupling device.

The link between the value of Tc and the value of Th is governed by the Snell-Descartes laws:

$$n ( fgi ) sin ( Tc ) = n ( ffc ) sin ( Th ) ,$$

with n(fgi) being the index of the core of the graded-index section Fgi; and n(ffc) being the index of the hollow-core fiber Fcc (approximately =1).

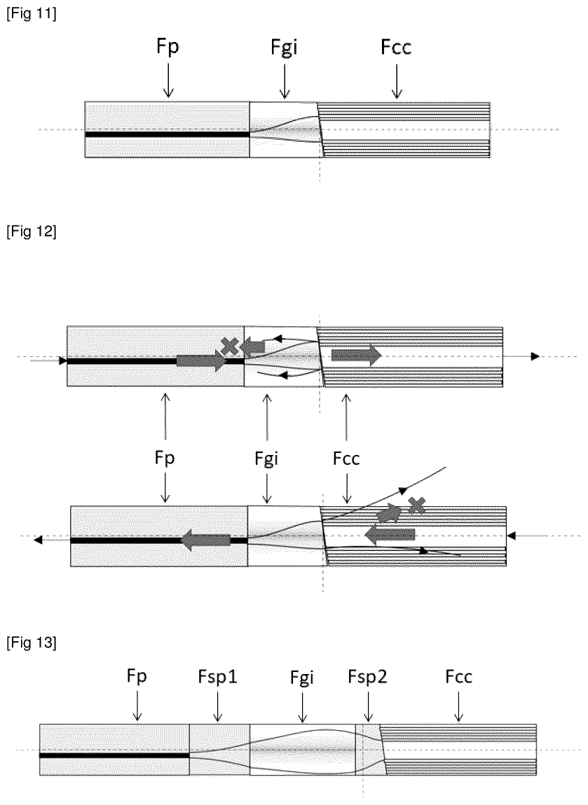

In this embodiment, it is worthwhile cleaving the hollow-core fiber Fcc at the same angle Tc, as illustrated in [FIG. 11]. This allows assembly by simply welding the various elements, namely the fiber Fp, the coupling device and the fiber Fcc, while facilitating their alignment along the same axis. The coupling device is then made up of an interface without cleavage with a solid fiber, a graded-index fiber section, and an interface with cleavage with a hollow-core fiber.

This embodiment also allows the optical beam to be matched to the mode diameter of the fibers at the ends. As illustrated in [FIG. 12], this embodiment also allows the optical reflections to be reduced in each of the two propagation directions of the optical beam.

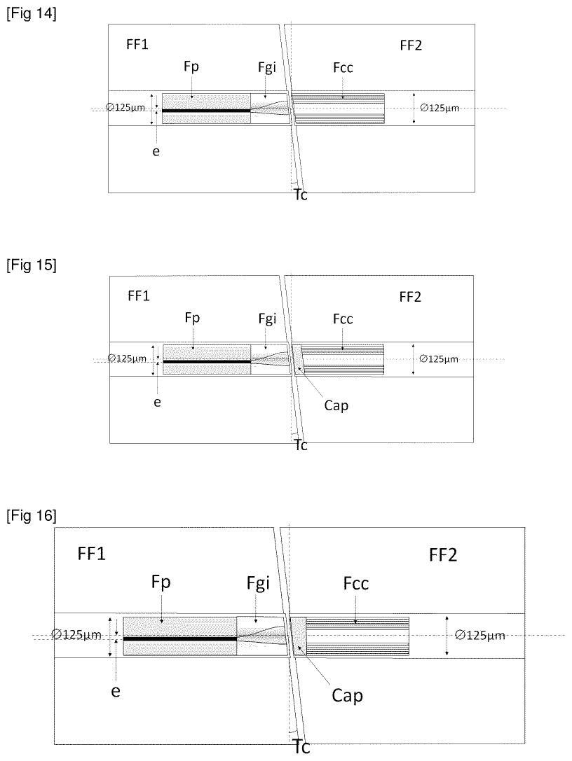

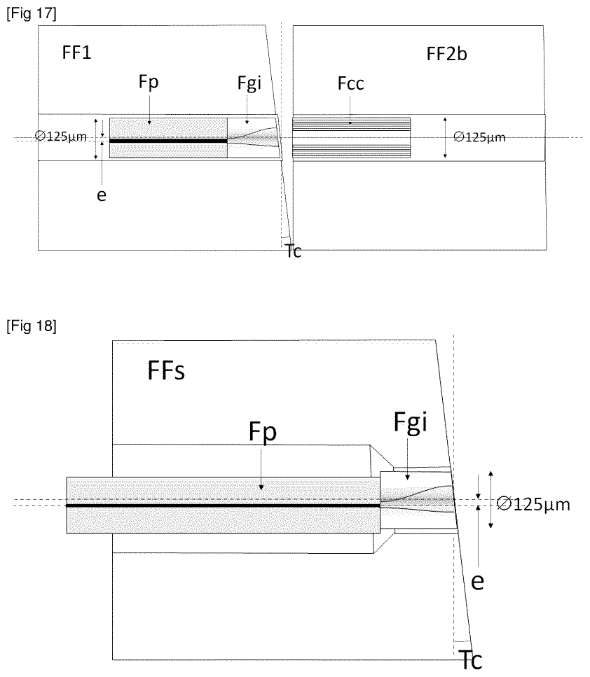

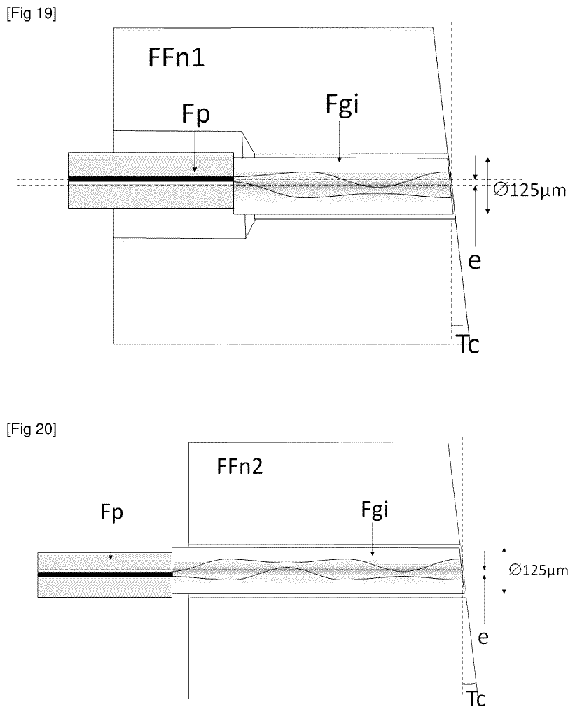

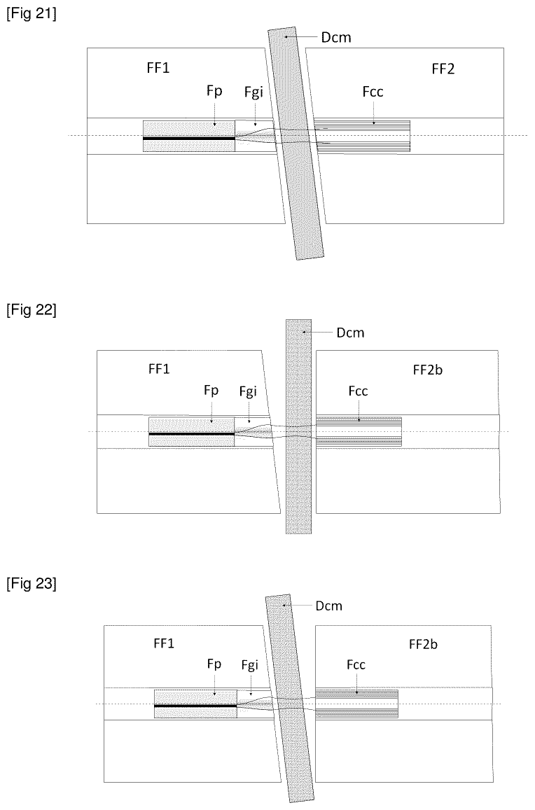

In one embodiment illustrated in [FIG. 13], pure silica fiber sections Fsp1 and Fsp2 are added in order to modify the magnification or focusing parameters of the optical beam in the coupling device. The coupling device is then made up of an interface without cleavage with a solid fiber, a pure silica section (Fsp1), a graded-index fiber section, a pure silica section (Fsp2), and an interface with cleavage with a hollow-core fiber.

[FIG. 13] illustrates the case whereby a pure silica fiber section is added both to the right and to the left of the graded-index fiber section Fgi, but it is possible for it to be added to only one side. The cleaving device can be made up of one or two sections of pure silica fiber (or none, as illustrated in [FIG. 11]). If a pure silica fiber section Fsp2 is interposed between the fiber Fgi and the fiber Fcc, the fiber cleavage at the angle Tc is disposed at this location. The computation of Tc as a function of Th is also governed by the Snell-Descartes laws:

$$n ( sp ) sin ( Tc ) = n ( ffc ) sin ( Th ) ,$$

with n(sp) being the index of the core of the pure silica section Fsp2; and n(ffc) being the index of the hollow-core fiber Fcc (approximately =1).

Such a coupling device between a single-mode or multi-core optical fiber, called solid fiber, and a hollow-core optical fiber, is simple to manufacture.

An example of a manufacturing method involves interposing a graded-index fiber section Fgi between a solid fiber Fp and a hollow-core fiber Fcc.

At least one core of the solid fiber Fp must be offset relative to the central axis of the graded-index fiber Fgi.

The solid fiber Fp must be welded or bonded, with this offset of the core, to the graded-index fiber Fgi, or optionally to a pure silica fiber section Fsp1 interposed between the fibers Fp and Fgi.

The graded-index fiber Fgi or the pure silica fiber section Fsp1 must be fractured (split) at a defined length of the weld. This length is computed in order to allow the graded-index section to function as a lens with the desired focal length and the pure silica sections as the object and image distances relative to this lens.

The contact surfaces between the graded-index fiber Fgi and the hollow-core fiber Fcc must be cleaved slantwise, and then assembled by welding or bonding. If a pure silica fiber section Fsp2 is interposed between the fibers Fgi and Fcc, the slantwise cleavage is between the fibers Fsp2 and Fcc.

In the case of welding, the welding is carried out under an electric arc in a standard optical fiber welding machine. This assembly requires optimization of the welding programs.

Throughout all the steps of the manufacturing method, the various fibers and fiber sections are held end-to-end in the same straight alignment.

In one embodiment illustrated in [FIG. 14], optical connectors, called ferrules, or connector ferrules, with standard dimensions, are used in order to facilitate connection and disconnection actions between, on one side, a single-mode or multi-core fiber, called solid fiber, Fp, and, on the other side, a hollow-core fiber, Fcc. The solid fiber and the hollow fiber are inserted into their respective ferrule FF1 and FF2. The connection between the two fibers (solid and hollow) is established mechanically by aligning and bringing together the two ferrules FF1 and FF2 until the two fibers are almost in mechanical contact.

Each ferrule also acts as a protective element that is easy to handle when the solid fiber and the hollow-core fiber are not connected to each other. Typically, with a graded-index fiber section with a quadratic constant for the graded-index section (or quadratic coefficient g0) of 4.3 mm−1, an offset e of the order of 32 μm yields a cleavage angle Tc of 8 degrees, for a multi-core fiber with a standard outer diameter of 125 μm. In order to achieve low optical reflection, the typical angle of the ferrules for a solid single-mode fiber is 8 degrees.

A relationship between e and Tc is:

$$e = Pi * Tc / ( g * 180 ) .$$

It is then possible to insert this device into a ferrule perforated at substantially the same diameter of 125 μm with a cleavage angle of 8° at the end. The hollow-core fiber also can be inserted into an identical connector with a cleavage angle of 8°. Upon connection, the two ferrules come into mechanical contact.

In one embodiment illustrated in FIGS. 15 and 16, the end of the hollow-core single-mode fiber is protected by a pure silica fiber section, Cap. This section acts as a cap to mechanically protect the end of the hollow fiber when it is implemented in the ferrule (with a possible honing operation) and limits the introduction of any impurities into the hollow portion. This pure silica section can be welded to the hollow fiber with a cleavage angle ([FIG. 15]), or without a cleavage angle ([FIG. 16]).

In one embodiment illustrated in [FIG. 17], the hollow-core fiber Fcc is inserted into a ferrule FF2b without any cleavage angle, i.e., with an angle of 0°. The graded-index sections then need to be adapted in order allow a working distance to be provided for the optical beam in the free space between the two connectors.

In one embodiment illustrated in [FIG. 18], welding together various types of fiber sections uses a standard single-mode fiber Fp with an offset e relative to the axis of the graded-index fiber sections Fgi and optionally of the pure silica sections. However, the offset does not allow the assembly to be maintained within a diameter of 125 μm, with each section having this same diameter. A special ferrule FFs is then necessary, with guidance with a diameter of 125 μm only over a length that is shorter than that of the graded-index section, and guidance with a greater diameter along the single-mode fiber.

The length of the 125 μm guide is typically of the order of 380 μm (that is, Pi/(2*g)).

However, this implementation uses a non-standard ferrule. A standard ferrule can be used by increasing the length of the graded-index fiber section. This latter length can be a multiple of 760 μm (that is, Pi/g), for example, 1.14 mm, as illustrated with the ferrule FFn1 in [FIG. 19], or 1.90 mm as illustrated with the ferrule FFn2 in [FIG. 20].

The use of a ferrule in these embodiments allows a device Dcm to be inserted between the two connectors, such as an anti-reflective treatment or any thin film device for implementing optical filtering or additional mechanical protection (water repellent or hydrophobic coatings, scratch and abrasion protection). A thin glass slide also can be inserted between the two ferrules. This glass slide can have an optical function, such as anti-reflection, filtering and also a mechanical protection function. This glass slide can be inserted between the two ferrules each with a honing angle of 8°. It is also possible to insert this glass slide between two ferrules with a different angle, such as, for example, a ferrule at 8° for the solid fiber and at 0° for the hollow fiber. FIGS. 21, 22 and 23 illustrate 3 variations of the mechanical alignment of the glass slide Dcm between ferrules: with an identical angle or with different angles.

1. A coupling device for coupling between a single-mode or multi-core optical fiber, called solid fiber, and a hollow-core optical fiber, the coupling device comprising:
the solid fiber, a graded-index fiber section, and the hollow-core fiber, wherein:
the graded-index fiber section is coupled to a core of the solid fiber with a radial offset relative to the central axis of the graded-index fiber section; and
the graded-index fiber section is coupled to the hollow-core fiber, with a contact surface of the hollow-core fiber being cleaved at an angle relative to a plane orthogonal to the central axis, with a value of said angle being a function of the radial offset and parameters of the graded-index fiber.

2. The coupling device as claimed in claim 1, further comprising at least one pure silica section adjacent to one side and/or another side of the graded-index fiber section.

3. The coupling device as claimed in claim 2, wherein the pure silica section is between the solid fiber and the graded-index fiber section.

4. The coupling device as claimed in claim 2, wherein the pure silica section is between the graded-index fiber section and the hollow-core fiber.

5. The coupling device as claimed in claim 2, comprising a first pure silica section between the solid fiber and the graded-index fiber section, and a second pure silica section between the graded-index fiber section and the hollow-core fiber.

6. The coupling device as claimed in claim 1, wherein the graded-index fiber section is welded to the hollow-core fiber.

7. The coupling device as claimed in claim 4, wherein the pure silica section is welded to the hollow-core fiber.

8. A method for manufacturing a coupling device, between a single-mode or multi-core optical fiber, called solid fiber, and a hollow-core fiber, the method comprising:
welding the solid fiber to a graded-index fiber section, or to a first pure silica section, which is welded to the graded-index fiber section, with a radial offset of a core of the solid fiber-relative to a central axis of the graded-index fiber section;
splitting the graded-index fiber section in order to give the graded-index fiber section a defined length, involving cleaving relative to a plane orthogonal to the central axis, at an angle whose value is a function of the offset and parameters of the graded-index fiber;
splitting the hollow-core fiber with the cleavage at the angle;
welding the hollow-core fiber to the graded-index fiber section, with the cleavage at the angle;
with the solid fiber, the graded-index section and the hollow-core fiber being parallel to each other.

9. A method for manufacturing a coupling device, between a single-mode or multi-core optical fiber, called solid fiber, and a hollow-core fiber, comprising:
welding the solid fiber to a graded-index fiber section, or to a first pure silica section, which is welded to the graded-index fiber section, with a radial offset of a core of the solid fiber relative to a central axis of the graded-index fiber section;
welding the graded-index fiber section to a second pure silica section;
splitting the second pure silica section in order to give the second pure silica section a defined length, involving cleaving relative to a plane orthogonal to the central axis, at an angle whose value is a function of the offset and parameters of the graded-index fiber;
splitting the hollow-core fiber with the cleavage at the angle;
welding the hollow-core fiber to the second pure silica section, with the cleavage at the angle;
with the solid fiber, the graded-index section, the second pure silica section and the hollow-core fiber being parallel to each other.

10. The coupling device as claimed in claim 1, wherein the device further comprises a first connection ferrule and a second connection ferrule, wherein the graded-index fiber section and the solid fiber are inserted into the first connection ferrule, and the hollow-core fiber is inserted into the second connection ferrule, with the first ferrule and the second ferrule being able and configured to connect to and disconnect from each other.

11. The coupling device as claimed in claim 10, further comprising a thin film-on-strip type device, between the first ferrule and the second ferrule.

12. The coupling device as claimed in claim 11, wherein the thin film device is an anti-reflective treatment.

13. The coupling device as claimed in claim 5, wherein the second pure silica section is welded to the hollow-core fiber.
